(19) United States
(12) Patent Application Publication
(10) Pub. No.: US 2009/0079750 A1
(43) Pub. Date: Mar. 26, 2009

(54) Message Customization with Dynamically Added Content

(76) Inventors: Yaron Waxman, Ramat Can (IL); Igor Magazinik, Tel Aviv (IL); Talmon Marco, New York, NY (US)

Correspondence Address: CENTURY IP GROUP, INC. [Main], P.O. BOX 7333, NEWPORT BEACH, CA, 92658-7333, US

(21) Appl. No.: 11/861,050

(22) Filed: Sep. 25, 2007

(51) Int. Cl. G09G 5/00

(52) U.S. Cl. 345/581

(57) ABSTRACT

A dynamic message animation method comprising customizing a media file by embedding references to custom content into the media file, wherein the custom content is stored in one or more resources; and including the media file in an electronic message deliverable to a destination, wherein a media player at the destination retrieves the custom content from said one or more resources, based on the references embedded in the media file, and wherein the media player at the destination reproduces the custom content.

### FIELD OF INVENTION

This invention relates generally to animated messages in a computing environment and, more particularly, to dynamically adding custom content to messages.

### BACKGROUND

One of the features of instant messaging is the ability to send animated messages to another user. Animated messages can be sent as GIF files called “emoticons” or as Media files called “winks.”

A wink is a short animation clip usually around 10 seconds that one user can send to another user. Winks are played on the receiver's computer screen either automatically or after user confirmation. In most implementations, the wink will play over a “chat window” of the instant messaging interface displayed on the receiver's screen.

Animated messages are typically included in fixed animation files created by either a messaging service provider (e.g., AOL) or by a third party as a final animation file. To send an animated message, a user has to browse a digital catalog that provides the user with an option to choose from different animated messages in the catalog.

When the selection is made, the animated message is included in an instant message. Unfortunately, beyond selecting an animated message from the catalog, a user cannot customize any part of the animation itself. Systems and methods are needed that allow a user to personalize a selected animated message.

### SUMMARY

The present disclosure is directed to systems and corresponding methods that dynamically add custom content to messages.

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one embodiment, a method for dynamically animating a message is provided. The method comprises customizing a media file by embedding references to custom content into the media file, wherein the custom content is stored in one or more resources; and including the media file in an electronic message deliverable to a destination, wherein a media player at the destination retrieves the custom content from said one or more resources, based on the references embedded in the media file, and wherein the media player at the destination reproduces the custom content.

In accordance with another embodiment, a system comprising one or more logic units is provided. The one or more logic units are configured to perform the functions and operations associated with the above-disclosed methods. In accordance with yet another embodiment, a computer program product comprising a computer useable medium having a computer readable program is provided. The computer readable program when executed on a computer causes the computer to perform the functions and operations associated with the above-disclosed methods and systems.

One or more of the above-disclosed embodiments, in addition to certain alternatives, are provided in further detail below with reference to the attached figures. The invention is not, however, limited to any particular embodiment enclosed.

### BRIEF DESCRIPTION OF THE DRAWINGS

Embodiments of the invention are understood by referring to the figures in the attached drawings, as provided below.

FIG. 1 is an example of an animated message with a custom image being displayed in a chat window, in accordance with one embodiment.

FIG. 2 is a flow diagram of a method for sending animated messages with custom content, in accordance with one embodiment.

FIG. 3 is a block diagram that illustrates how a media player interacts with a software agent and a template file, in accordance with one embodiment.

FIG. 4 is a flow diagram of a method for sending animated messages where a template file resides in a server, in accordance with one embodiment.

Features, elements, and aspects of the invention that are referenced by the same numerals in different figures represent the same equivalent, or similar features, elements, or aspects, in accordance with one or more embodiments.

### DETAILED DESCRIPTION OF EXEMPLARY EMBODIMENTS

The present disclosure is directed to systems and corresponding methods that add dynamic content to electronic messages.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

Animated messages may be personalized using customizable animation files hereafter referred to as template files. Template files are configured to include custom content that is displayed as part of an animated message when the animated message is played by a media player. A template file may contain one or more placeholders for custom content that is to be embedded into the template file.

In one embodiment, a user A may want to send an animated message to a user B with a custom message embedded therein. To accomplish this, user A using a computing system may select a template file from a digital catalog, for example, and embed a custom message (e.g., a custom text message) in a placeholder in the template file. The template file, including the custom message, may then be forwarded by way of an electronic messaging system to a computing system used by user B. When user B opens the message, a messaging application running on the computing system used by user B plays the message which includes the custom content included in the placeholder.

In portions of the following disclosure, the present invention may be disclosed, by way of example, as applicable to an instant messaging service. It is noteworthy, however, that the concepts and principles disclosed herein may be equally applicable to other messaging services such as email, or any other type of messaging service that allows a user to transmit a message including text, hyperlink, audio or video content.

A template file may include a placeholder that can be associated with a virtual object displayable on a computer screen. The virtual object, for example, may be an image or other content stored on the sender's system, the receiver's system or both. In addition to custom text, in certain implementations, users may also have the option to include custom images in a template file. For example, user A may select a template file from a digital catalog that displays an angry man yelling and shaking his fists at an object displayed on a display screen.

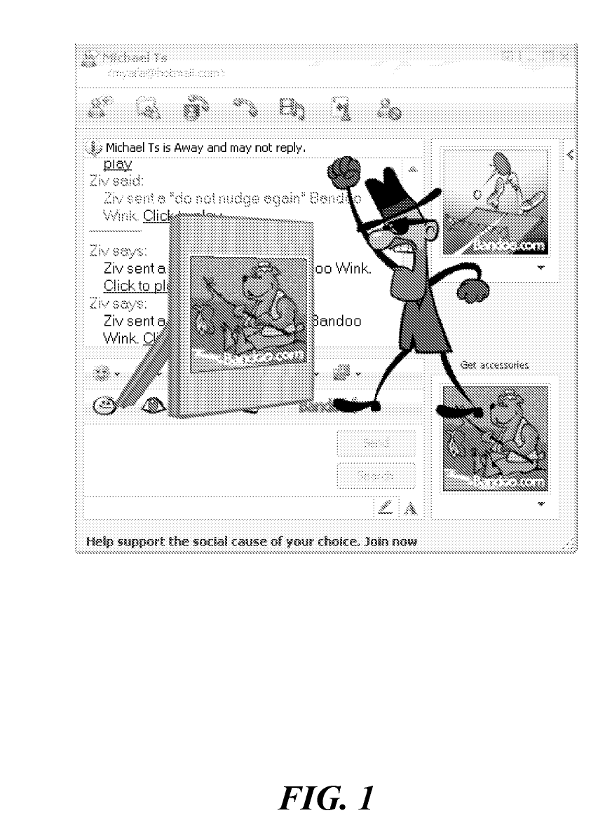

Referring to FIG. 1, for example, a user A may select an image of user B to be included in the placeholder a template file, such that when user B opens a message including the template file, user B views an animated image of the angry man yelling and shaking his fists at the image of user B. In this example, the animated content for the angry man may be retrieved from user A's computer prior to the message being sent, and the image of user B may be retrieved from user B's computer after the message is received on user B's computer.

In another example, user A may designate a reference to an application on which user B is working on to be included in the template's placeholder, at the time when the message is received on user B's system. Accordingly, when user B opens the message, the angry man is displayed yelling at the designated application window on which user B is working.

Content may be retrieved from a server on a network such as a web server on the Internet. Such content may be formatted in HTML, XML, or any other format suitable for referencing dynamic content on the web. The content may be streaming data such as video or audio, web pages, stock prices, weather information, news feeds, Really Simple Syndication (RSS) feeds, etc. For example, an animated message may display a person sitting on a couch watching TV, with the TV showing a video/audio stream (e.g., a clip from YouTube). The TV represents a placeholder for online video/audio in the animated message.

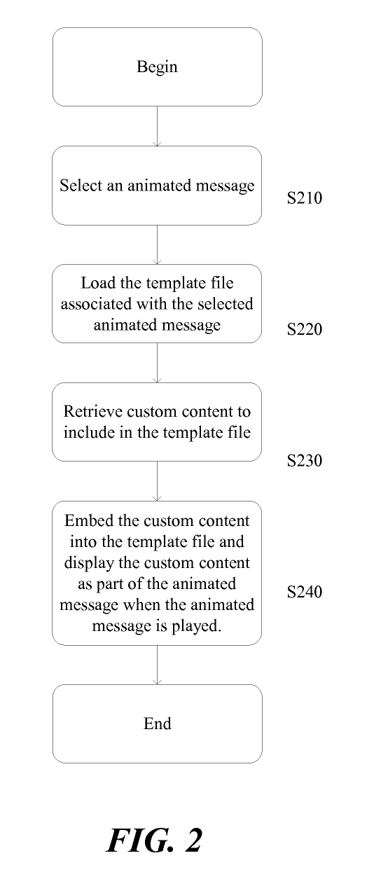

Referring to FIG. 2, a method for including custom content in a message in accordance with one embodiment is provided. Custom content may be added dynamically to a message by selecting an animated message (S210), loading a template file associated with the selected animated message (S220), retrieving custom content to include in the template file (S230), and then embedding the custom content into the template file and displaying the custom content as part of the animated message when the animated message is played (S240).

The custom content may be embedded in one or more placeholders in the template. Depending on implementation, custom content may be dynamically handled on the client-side, server-side, or a combination of both. On the client-side, software agents running on user computers (e.g., animation applications, add-ons, etc.) handle the animated message. On the server-side, a server handles the animated message. The term handling refers to the processes that are performed to parse a template file included in a message for data included in the placeholders and playing the content referenced by the placeholders.

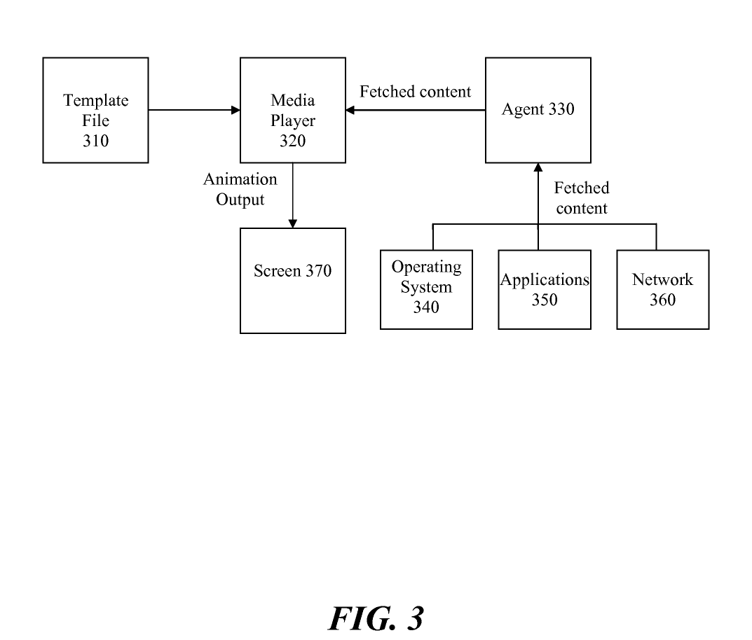

FIG. 3 illustrates an exemplary embodiment in which an animated message is handled on the client-side using, for example, a media player executed on a client computer. In this exemplary embodiment, software agent 330 loads the template file 310 and retrieves custom content for inclusion in placeholders in the template file 310. In this embodiment, template file 310 is a media file containing one or more placeholders, for example.

As shown, content may be provided by operating system 340, applications 350 or network 360 and embedded into template file 310. Once the custom content is embedded into template file 310, a media player 320 may be utilized to display the custom content as part of the animated message on screen 370. Screen 370 may be the display screen on a designated recipient's system, or a display screen on the sender's system, for example.

In an exemplary embodiment, Adobe Flash Player and Flash formatted files may be utilized for creating media files or playing the media files. Depending on implementation, however, other media players, or other media file formats, may be used to handle animated messages, as provided herein. Further, in some embodiments, the functionality provided by agent 330 may be implemented into media player 320, such that media player 320 is configured to directly retrieve custom content and embed the custom content into template files, without the presence of an independent agent 330.

In some embodiments, template files may be sent from a sender's system directly (e.g. through a peer-to-peer network) to a receiver's system. Alternatively, template files may be transmitted over a network, by way of a server. Thus, template files may reside locally on a sender's system or on a remote server. It is also possible for some template files to reside locally and some to reside on a remote server. Some embodiments may cache commonly used template files.

Custom content may be embedded in placeholder included in a template file in various stages or orders. For example, consider a template file that includes three placeholders X, Y, and Z. Custom content embedded in X may be retrieved locally from the system used by a sender to send a message. The template with content included in placeholder X may then be placed in a message sent to a receiver system over a network.

In one embodiment, a network server while handling the transport of the message from the sender to the receiver may embed content into placeholder Y. Once received by the receiver, a software agent 330 on the receiver's system may locally retrieve custom content to be embedded in placeholder Z of template file. Template file 310 may finally be provided to a media player and displayed on a display screen on the receiver's system.

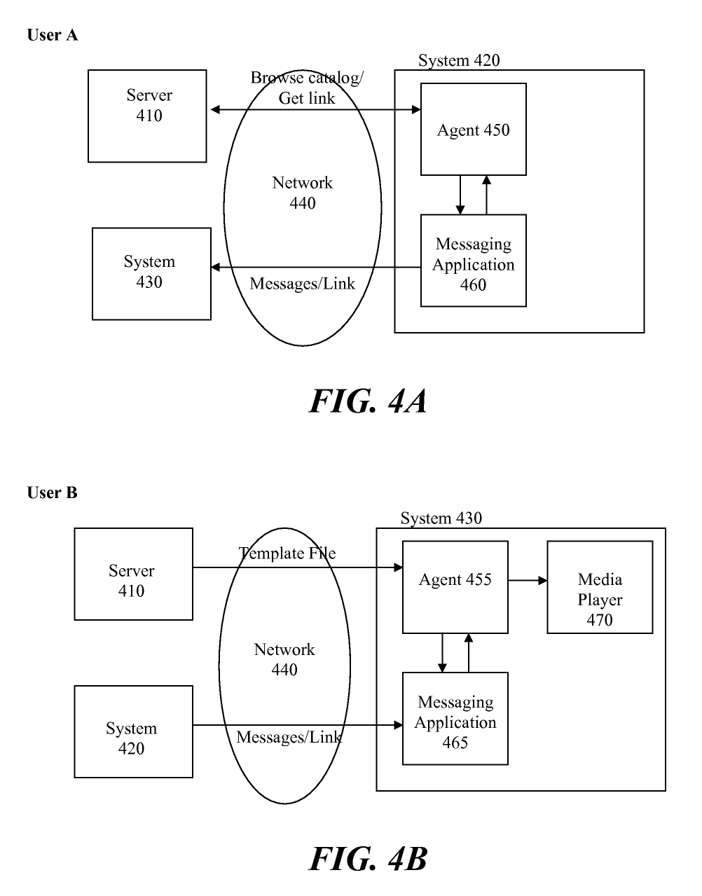

Referring to FIGS. 4A and 4B, custom content may be dynamically added to an animated message where template file 310 associated with the animated message resides on a server on network 440, for example. Referring to FIG. 4A, agent 450 may be executed on a system 420 used by user A to send a message. User A may browse a digital catalog of animated messages located on server 410 and select an animated message to send. Once user A sends the message, agent 450 communicates with user B's agent 455.

Agents 450 and 455 may communicate with each other over network 440 through messaging applications 460 and 465, respectively. In some embodiments, agents 450 and 455 may communicate with each other through an open channel parallel to the communication channel between message applications 460 and 465.

Referring to FIG. 4B, user B's agent 455 may receive the link to template file 310 and download template file 310 from server 410 to system 430. In one embodiment, agent 455 retrieves the custom content that is identified by the placeholders in template file 310. Agent 455 embeds the retrieved content into template file 310. When user B plays the animated message, Media player 470 displays the animated message on system 430 display screen.

The invention can take the form of an entirely hardware embodiment, an entirely software embodiment or an embodiment containing both hardware and software elements. A software embodiment may include, but not be limited to, to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Other components may be coupled to the system. Input/output or I/O devices (including but not limited to keyboards, displays, pointing devices, etc.) can be coupled to the system either directly or through intervening I/O controllers. Network adapters (e.g., modem, cable modem, Ethernet cards) may also be coupled to the system to enable the data processing system to become coupled to other data processing systems or remote printers or storage devices through intervening private or public networks.

The logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may be comprise one or more modules that execute on one or more processors in a distributed, non-distributed, or multiprocessing environment.

Therefore, it should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. A message customization method comprising:
selecting an animated message to be included in an instant message for delivery to a designated destination;
loading a template file associated with the selected animated message;
retrieving custom content to include in the template file; and
embedding the custom content into the template file, such that the custom content is displayed as a part of the animated message in a display window of an instant message viewer at the destination.

2. The method of claim 1, wherein the template file is a customizable media file.

3. The method of claim 1, wherein the custom content is referenced by data included in one or more placeholders in the template file.

4. The method of claim 3, wherein the placeholders reference content available on one or more resources.

5. The method of claim 4, wherein at least one of said one or more resources is local to a sender of the instant message.

6. The method of claim 4, wherein at least one of said one or more resources is local to a receiver of the instant message.

7. The method of claim 4, wherein at least one of said one or more resources is remote to a sender of the instant message.

8. The method of claim 4, wherein at least one of said one or more resources is remote to a receiver of the instant message.

9. A dynamic animated message system comprising:
a logic unit for selecting an animated message to be included in an instant message for delivery to a designated destination;
a logic unit loading a template file associated with the selected animated message;
a logic unit retrieving custom content to include in the template file; and
a logic unit embedding the custom content into the template file, such that the custom content is displayed as a part of the animated message in a display window of an instant message viewer at the destination.

10. A computer program product comprising a computer useable medium having a computer readable program, wherein the computer readable program when executed on a computer causes the computer to:
customize a media file by embedding references to custom content into the media file, wherein the custom content is stored in one or more resources; and
include the media file in an electronic message deliverable to a destination,
wherein a media player at the destination retrieves the custom content from said one or more resources, based on the references embedded in the media file, and
wherein the media player at the destination reproduces the custom content.

11. The computer program product of claim 10, wherein the custom content is stored in a resource local to a sender of the electronic message.

12. The computer program product of claim 10, wherein the custom content is stored in a resource local to a receiver of the electronic message.

13. The computer program product of claim 10, wherein the custom content is stored in a resource remote to a sender of the electronic message.

14. The computer program product of claim 10, wherein the custom content is stored in a resource remote to a receiver of the electronic message.

15. The computer program product of claim 10, wherein the custom content comprises at least one of an image, text, streaming audio/video, and data provided over an internet protocol.

16. The computer program product of claim 10, where in the media file is transmitted from a sender's system directly to a receiver's system in a peer-to-peer network.

17. The computer program product of claim 10, wherein the media file is transmitted from a server system directly to a receiver's system in a local network.

18. The computer program product of claim 10, wherein the media file is transmitted from a server system directly to a receiver's system in a remote network.

19. The computer program product of claim 10, wherein commonly used media files are cached.

20. The method of claim 1, wherein the custom content comprises at least one of an image, text, streaming audio/video, and data provided over an internet protocol.
